(19) United States
(12) Patent Application Publication
(10) Pub. No.: US 2026/0025863 A1
(43) Pub. Date: Jan. 22, 2026

(54) DEVICE CONNECTION APPARATUS AND METHOD

(71) Applicant: Motive Software Solutions (UK) Ltd, London (GB)

(72) Inventor: Colin GREALISH, Brighton (GB)

(73) Assignee: Motive Software Solutions (UK) Ltd, London (GB)

(21) Appl. No.: 19/271,675

(22) Filed: Jul. 16, 2025

(30) Foreign Application Priority Data
Jul. 16, 2024 (GB) 2410365.7

(51) Int. Cl. H04W 76/11; H04W 24/08; H04W 84/18

(52) U.S. Cl. CPC H04W 76/11; H04W 24/08; H04W 84/18

(57) ABSTRACT

Described is an apparatus including a memory configured to store computer-readable instructions; and a processor configured to execute the computer-readable instructions which, when executed, cause the apparatus to: receive a device online indication indicative of a change of network status of an Internet of Things (IoT) device from an offline state to an online state; obtain an address of the IoT device in dependence on the change of network status of the IoT device from the offline state to the online state; and transmit a push signal to the IoT device using the address to establish communication between the apparatus and the IoT device. The apparatus facilitates improved communication with IoT devices, for example low power IoT devices.

### FIELD

The present disclosure relates to apparatus and methods for communication between device, in particular communication with Internet of Things (IoT) devices, for example low power IoT devices. Examples disclosed herein relate to apparatus, systems, computer-implemented methods, and computer-readable media including computer software, for communication with an IoT device.

### INTRODUCTION

Management of devices, such as Internet of Things, IoT, devices, presents challenges. IoT devices can be difficult to make communication contact with. These devices may be categorised as “low power” in some cases because they are not connected to a mains electricity supply, and instead have their own dedicated power supply, such as a battery. This means that these devices cannot be connected to a mobile network all the time, because doing so would drain the device battery quickly. Instead these devices may check-in infrequently with another apparatus using very small messages for a very small amount of time.

Managing these devices typically involves contacting the device and asking it to contact a management server for management operations to be performed. However, current techniques have drawbacks, such as wasting power expended by the device power supply in making non meaningful communications when no communication with the management server is needed, or experiencing delays in messaging between the management server and the device in waiting for device to come online so the management server can communicate with it.

A solution is required that improves management of, and communications with, an Internet of Things device.

### SUMMARY

In an aspect, there is provided an apparatus including a memory configured to store computer-readable instructions; and a processor configured to execute the computer-readable instructions which, when executed, cause the apparatus to: receive a device online indication indicative of a change of network status of an Internet of Things, IoT, device from an offline state to an online state; obtain an address of the IoT device in dependence on the change of network status of the IoT device from the offline state to the online state; and transmit a push signal to the IoT device using the address to establish communication between the apparatus and the IoT device.

The apparatus may be configured to transmit a monitoring request to a mobile network to cause the mobile network to monitor for a change of network status of the IoT device from the offline state to the online state; and receive an IoT device network connection notification from the mobile network as the device online indication, the IoT device network connection notification indicative of detection, by the mobile network, that the IoT device has changed network status from the offline state to the online state.

The apparatus may be configured to receive the IoT device network connection notification via an exposure feature of the mobile network.

If the mobile network is a 4G network, the apparatus may be configured to receive the IoT device network connection notification using a Service Capability Exposure Function, SCEF, of the exposure feature. If the mobile network is a 5G network, the apparatus may be configured to receive the IoT device network connection notification using a Network Exposure Function, NEF, of the exposure feature.

The apparatus may be configured to obtain the address of the IoT device by receiving an IoT device address allocation from the mobile network, the IoT device address allocation indicative of the address of the IoT device allocated to the IoT device by the mobile network. The IoT address allocation may be determined using accounting information in the mobile network.

The apparatus may be configured to, following obtaining of the address of the IoT device, establish a connection identifier indicative of a communication session between the IoT device and the apparatus. If the address of the IoT device changes, the apparatus may be configured to continue communication with the IoT device using the connection identifier.

The apparatus may be configured to receive a connection request for connection to the IoT device from an external apparatus; and query the network status of the IoT device in dependence on receipt of the connection request from the external apparatus, to cause receipt of the device online indication indicative of the change of network status of the IoT device from the offline state to the online state. In some examples the external apparatus may be part of the apparatus; that is, the apparatus may contain the external apparatus

The connection request may include a unique identifier of the IoT device. The unique identifier may include an International Mobile Equipment Identity, IMEI; Mobile Station International Subscriber Directory Number, MSISDN; International Mobile Subscriber Identity, IMSI, Subscription Permanent Identifier, SUPI; Subscriber Concealed Identifier, SUCI; Permanent Equipment identifier. PEI; or Generic Public Subscription Identifier, GPSI, of the IoT device.

The apparatus may be configured to receive the connection request; store the connection request in a buffer; and transmit the push signal to the IoT device in dependence on the obtaining of the address of the IoT device.

Following establishing the communication between the apparatus and the IoT device, the apparatus may be configured to transmit a message received from the external apparatus to the IoT device. Following establishing the communication between the apparatus and the IoT device, the apparatus may be configured to transmit a message received from the IoT device to the external apparatus. Thereby, the apparatus may facilitate communication between the external apparatus and the IoT device.

Following establishing the communication between the apparatus and the IoT device, the apparatus may be configured to one or more of: transmit a message to the IoT device; receive a message from the IoT device; transmit a message to the external apparatus; and receive a message from the external apparatus. Thereby, the apparatus may facilitate communication between the external apparatus and the IoT device and/or between itself and the external apparatus and/or the IoT device.

In a further aspect, there is provided an apparatus including: means for receiving a device online indication indicative of a change of network status of an Internet of Things, IoT, device from an offline state to an online state; means for obtaining an address of the IoT device in dependence on the change of network status of the IoT device from the offline state to the online state; and means for transmitting a push signal to the IoT device using the address to establish communication between the apparatus and the IoT device.

In a further aspect, there is provided a system for communication with an IoT device, the system including any apparatus disclosed herein; and the IoT device. The system may include the external apparatus. The system may include a mobile network. The IoT device may be one or more of: a gas meter, an electricity meter, a water meter, a sensor, an alarm, a smoke alarm, a carbon monoxide alarm, an intruder alarm, and a climate controller, for example. Many other suitable devices may be the IoT device. The computer network may include a plurality of IoT devices.

In a further aspect, there is provided a computer-implemented method for communication with an IoT device, the method including: receiving a device online indication indicative of a change of network status of an Internet of Things, IoT, device from an offline state to an online state; obtaining an address of the IoT device in dependence on the change of network status of the IoT device from the offline state to the online state; and transmitting a push signal to the IoT device using the address to establish communication between the apparatus and the IoT device.

In a further aspect, there is provided a computer readable medium including computer software which, when executed, is arranged to perform any method disclosed herein. In a further aspect, there is provided a non-transitory, computer-readable storage medium storing instructions thereon that, when executed by one or more electronic processors, causes the one or more electronic processors to carry out any method disclosed herein.

### BRIEF DESCRIPTION OF THE DRAWINGS

One or more examples will now be described, by way of example only, with reference to the accompanying drawings, in which:

FIG. 1A shows an example apparatus for communication with an IoT device according to examples disclosed herein;

FIG. 1B shows an example apparatus for communication with an IoT device of according to examples disclosed herein;

FIG. 1C shows a system according to examples disclosed herein;

FIG. 2 shows an example of monitoring an IoT device according to examples disclosed herein;

FIG. 3 shows an example of monitoring an IoT device according to examples disclosed herein;

FIG. 4 shows an example of connecting to an IoT device according to examples disclosed herein; and

FIG. 5 shows an example method of monitoring an IoT device according to examples disclosed herein.

### DETAILED DESCRIPTION

The present disclosure relates to apparatus and methods for communication with Internet of Things (IoT) devices, for example low power IoT devices. These devices may be categorised as “Low Power” because they are not connected to a mains electricity supply, and instead have their own dedicated power supply, such as a battery.

Managing these devices typically involves a computing apparatus contacting the device and asking it to contact a management server for management operations to be performed (such as software updating or taking sensor readings from the IoT device). However, current techniques can have drawbacks, such as wasting power expended by the device power supply in making non-meaningful communications (e.g. the IoT device coming online without any communications with the management server being needed at that time), or experiencing delays in messaging between the management server and the IoT device (for example, if the IoT device comes online one a week then the management server may wait for a significant length of time (e.g. up to a week) to communicate with the IoT device).

It is known to use short messaging service (SMS) messaging, whereby an SMS message is sent to an IoT device to cause it to connect to the management apparatus for management operations to take place. A problem with this method is that the computationally-constrained nature of low-power IoT devices means they often do not have capacity for SMS messaging. Another known method is to use a “device check-in”, which may involve the IoT device periodically connecting to the server/management apparatus to check if there is a management operation ready to be performed. A problem with this method is that if the IoT device checks in frequently, the IoT device uses a lot of device power, and therefore battery power, to connect to the server to check in, and the battery power is used up quickly, even if there are no management operations pending for the IoT device. If the IoT device does this check-in process more infrequently, while the device battery may last longer, there may be a long wait for the management operations to be performed.

A further method for IoT device communication is to use Direct Push to the IoT device. Direct push means the server/management apparatus connects directly to the IoT device. A problem with this method can be that the server does not know when the IoT device is online, and the IoT device may only be online for a very short time. Therefore there may be push messaging from the server to the IoT device which is not received when the IoT device is offline. Also, the internet protocol (IP) address (i.e. a unique device address) of the IoT device may be reallocated when the IoT device goes offline, and so the IP address may not be known to the server.

Examples disclosed herein aim to overcome problems in the art. Examples disclosed herein may advantageously provide a polling free solution which may be integrated with existing telecommunication networks in such a way that they may determine when an IoT device switches on its radio (i.e. comes online) and connects to the apparatus which manages the communication with the IoT device. Examples disclosed herein may advantageously integrate with a telecommunications network, to allow for provision of notifications when the IoT device is allocated an IP address by the telecommunications network (due to the IoT device coming online). Based on the IoT device being determined to be online (i.e. radio communications being active) and having an IP address allows the apparatus to contact/communicate with the IoT device in an improved way.

Throughout this document, the concept “push” means the initiation of a spontaneous connection to a device (e.g. an IoT device) from the server (or other management apparatus). Throughout this document, the concept “Internet of Things, IoT” may alternatively be called “machine-to-machine, M2M”, and may be understood to mean systems of two or more apparatus and/or devices which are connected with each other and which can collect, store, and/or exchange data with one another without necessarily needing human input or interaction. In some examples the apparatus/devices may communicate directly; in some examples the apparatus/devices may communicate indirectly, via a separate server or the cloud. The “mobile network” may alternatively be called a “cellular network”.

Examples disclosed herein may find applications in: mobile telecommunications; Internet of Things systems; power saving devices; Open Mobile Alliance (OMA) and 3GPP standards; utilities (e.g. gas, water, electricity supply to a building); and “Smart Cities” of communicatively connected urban entities.

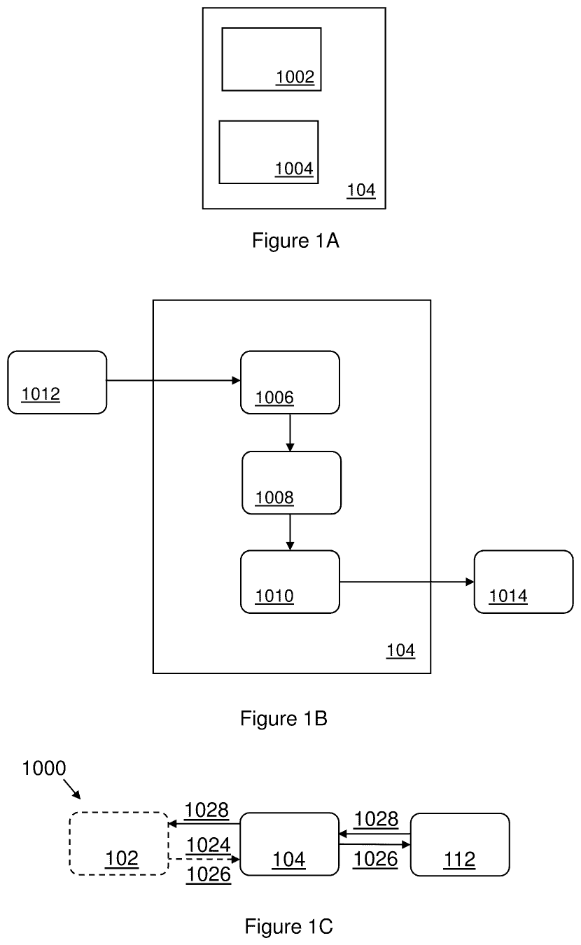

FIG. 1A shows an example apparatus 104 for communication with an IoT device. The apparatus 104 may be called a “device management” apparatus or “device management” server in some examples. The apparatus 104 includes a memory 1002 configured to store computer-readable instructions, and a processor 1004 configured to execute the computer-readable instructions. As discussed in relation to FIG. 1B, the computer-readable instructions, when executed, cause the apparatus 104 to operate to communicate with an IoT device.

FIG. 1B shows the apparatus 104 of FIGS. 1A and 1s configured to receive 1006 a device online indication 1012. The device online indication 1012 is indicative of a change of network status of an IoT device from an offline state to an online state. The apparatus 104 is configured to obtain 1008 an address of the IoT device in dependence on the change of network status of the IoT device from the offline state to the online state. The apparatus 104 is then configured to transmit 1010 a push signal 1014 to the IoT device using the address to establish communication between the apparatus 104 and the IoT device.

In this way the apparatus 104 sends a communication to the IoT device once it has received an indication that the IoT device is online, rather than sending communications repeatedly while the IoT device is offline, until one can be received by the IoT device once it is online. Further, the apparatus 104 is informed of the address (e.g. IP address) of the IoT device once the IoT device comes online to allow for it to communicate with the IoT device. Once communication is established the apparatus 104 can send a push signal to communicate with the IoT device. The apparatus 104 therefore operates in an improved way, without redundancy of attempts to communicate with an offline IoT device, and provides improved battery usage of the IoT device as the IoT device is not required to come online on the chance there is a communication from the apparatus 104, if there is no communication to be made while online. This may be thought of as a “polling-free push” method of establishing communication with an IoT device, since the method does not rely on polling to periodically query the status of the IoT device(s) in order to push a notification to an IoT device to establish communication with it.

FIG. 1B may be understood to show an apparatus 104 including: means for receiving 1006 a device online indication 1012 indicative of a change of network status of an Internet of Things, IoT, device from an offline state to an online state; means for obtaining 1008 an address of the IoT device in dependence on the change of network status of the IoT device from the offline state to the online state; and means for transmitting 1010 a push signal 1014 to the IoT device using the address to establish communication between the apparatus and the IoT device.

FIG. 1C illustrates a system 1000 configured for communication with an IoT device 112. The system 1000 includes an apparatus 104 such as those of FIGS. 1A and 1B, and the IoT device 112. The system 1000 may be thought of as a computer network. The system 1000 in some examples may include an external apparatus 102. The external apparatus 102 may be configured to transmit a connection request 1024 to the apparatus 104 for connection to the IoT device 112. The external apparatus 102 may be configured to transmit a message 1026 to the IoT device 112 via the apparatus 104 in some examples, such as a request for data, an IoT device operating software update, or other message. The IoT device 112 may report back one or more messages 1028 to the apparatus 104 in some examples, such as a sensor reading, internal battery status, or an operation status. Other signals may be transmitted/received between the system 1000 entities as described herein. In this way an external apparatus 102 can communicate with an IoT device 112.

In some examples the external apparatus 102 and the apparatus 104 may be part of the same device. In some examples the external apparatus 102 may be an apparatus configured to receive input requesting communication with the IoT device 112, to cause communication with the IoT device. Such input may be an automated input from a further device, and/or may be a user-provided input to a user interface of the external apparatus 102. Such an external apparatus 102 can communicate with the apparatus 104 in response to an input to cause the apparatus 104 to perform steps to communicate with the IoT device 112 such as the method described in relation to FIG. 1B.

While in this example one IoT device 112 is shown, in other examples, the system may include a plurality of IoT devices 112 which may be the same and/or different types of IoT devices 112. The IoT device(s) 112 may include, for example: a gas meter, an electricity meter, a water meter, a sensor, an alarm, a smoke alarm, a carbon monoxide alarm, an intruder alarm, or a climate controller, for example. There may be 2, 3, 4, 5, or more than 5 (e.g. 10, 20, 50 or more) IoT devices 112 in the system which the apparatus 104 can facilitate communication with as described herein.

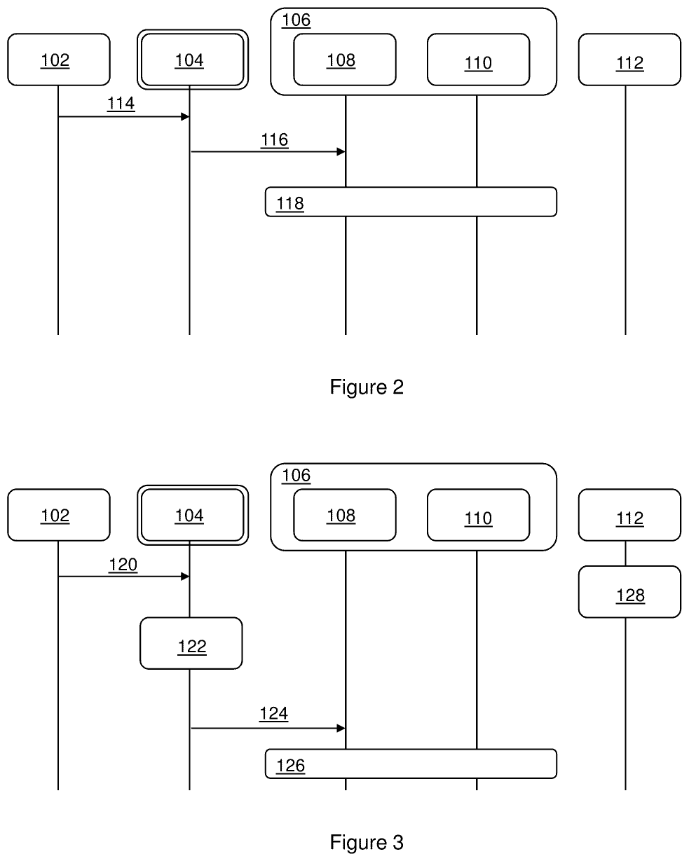

FIG. 2 shows an example architecture for establishing monitoring of an IoT device 112, for example to determine when the IoT device comes online (e.g. to determine that the IoT device 112 is communicative accessible on the network for subsequent communication). FIG. 2 shows an apparatus 104, such as the apparatus 104 described in relation to FIGS. 1A to 1C above, and which may be called a device management apparatus or component and will be described in detail below. FIG. 2 shows an IoT device 112 which is to be communicated with. In FIG. 2, the IoT device 112 is offline.

FIG. 2 shows an external apparatus 102. In some examples the external apparatus 102 may be part of the apparatus 104 and in some examples, as shown, the external apparatus 102 may be external to the apparatus 104. The external apparatus 102 may in some examples be a processor configured to run an application, and the application may be used to initiate communication with the IoT device 112. For example, the application may be a service program configured to update the software running on the IoT device, and/or may be an operational program configured to obtain data from the IoT device 112 such as sensor readings. The application may be operated at least in part by human interaction with the application, and/or may be operated at least in part by machine/automatic operation.

FIG. 2 shows a mobile (cellular) network 106. The mobile network 106 may be called a Mobile Network Core in some examples. It may include a number of components which manage a mobile network. The mobile network 106 in this example includes an exposure feature 108 and an address notifier 110. The exposure feature 108 enables the network capabilities, such as data and network services, to be made easily available, for example to communication service providers and third parties. The exposure feature 108 is the function that is configured to communicate when an IoT 112 device comes online. The address notifier 110 is configured to communicate the address (e.g. the IP address) of the IoT device 112.

The exposure feature 108 may include a Service Capability Exposure Function (SCEF), or Network Exposure Function (NEF), for example. If the mobile network is a 4G network, the apparatus 104 may be configured to receive the IoT device network connection notification using a SCEF of the exposure feature. 4G means a 4^{th} generation network such as Long-Term Evolution (LTE), Worldwide Interoperability for Microwave Access (WiMAX), and Evolved High Speed Packet Access (HSPA+), and is a type of mobile/cellular network. If the mobile network is a 5G network, the apparatus may be configured to receive the IoT device network connection notification using a NEF of the exposure feature. 5G means a 5^{th} generation network (sometimes called a next generation network, or New Radio, NR) and is a successor to 4G technology. In some examples, the mobile network may be a 6G (6^{th} generation network), a 7G (7^{th} generation network), 3G (3^{rd} generation network) or other type of mobile network capable of providing connectivity according to the examples disclosed herein. In such examples the apparatus 104 may be configured to receive the IoT device network connection notification using a suitable function of the exposure feature 108 (or equivalent) of the network 106 on which the apparatus 104 and IoT device 112 are operating.

There may be an interface between the external apparatus 102 and the IoT device 112 via the apparatus 104. There may be an interface between the IoT device 112 and the apparatus 104, which may be a device management protocol, such as OMA (Open Mobile Alliance) Lightweight M2M, OMA Device Management, OASIS Message Queuing Telemetry Transport (MQTT) or other. There may be a radio interface between the IoT device 112 and the mobile network 106. There may be an interface configured for notifying the apparatus 104 of the address of a IoT device 112; this interface may be the accounting information 110, for example as described in the 3GPP SGi interface, or other suitable interface. There may be an interface provided by the exposure function 108 which may be used by the apparatus 104; this interface may be, for example, an 3GPP T8 interface towards the SCEF, may be the 3GPP N33 interface towards the NEF, or another suitable interface.

As shown in the example of FIG. 2, the IoT device 112 is allocated in the apparatus 104 in a device management step 114; this means a process is initiated whereby the apparatus 104 is to communicate with the allocated IoT device 112. This includes informing the apparatus 104 of an identifier (i.e. a unique fixed identifier) of the device 112 within the network, such as the IMEI, MSISDN, IMSI, SUPI, SUCI, PEI, or GPSI of the device 112, so that the apparatus 104 can connect with the desired IoT device. In step 116, the apparatus 104 requests that monitoring for device reachability is applied for the identifier by the mobile network 106. That is, using the fixed identifier of the IoT device 112 to be communicated with, the apparatus 104 transmits a request to the mobile network 106 to request that the mobile network 106 monitors for when the IoT device 112 can be communicated with, i.e. comes online. This step 116 may be performed when the device 112 is allocated in step 114, but it may in other examples be performed at a different point in the overall process.

In step 118, the mobile network 106 sets up monitoring for the IoT device 112 in response to the request transmitted in step 116, so that the mobile network 106 can determine when the IoT device 112 comes online. In other words, the apparatus 104 may be configured to transmit a monitoring request 116 to a mobile network 106 to cause the mobile network 106 to monitor 118 for a change of network status of the IoT device 112 from the offline state to the online state.

In other examples, the mobile network 106 may monitor for a change of network status 118 of the IoT device 112 without requiring initiation of the monitoring in dependence on a request from the apparatus 104 or external apparatus 102. The mobile network 106 may simply monitor for the IoT device 112 online status change (for example, all the time, or periodically) irrespective of a request for communication with the IoT device 112. The process of FIG. 2 may be advantageous to focus the operation of the mobile network on monitoring for a change in IoT device status in dependence on a request for communication with the IoT device 112, i.e. the mobile network 106 monitors for the IoT device online status because there has been a request for communication with the IoT device 112.

FIG. 3 shows an example architecture for establishing monitoring of an IoT device, for example to monitor for the IoT device coming online for the provision of a request from the external apparatus 102 to the IoT device 112. As in FIG. 2, FIG. 3 shows an external apparatus 102, the apparatus 104, a mobile network 106 which includes an exposure feature 108 and an address notifier 110, and the IoT device 112. In FIG. 3, the IoT device 112 is offline 128.

In FIG. 3, the external device 102 determines that the IoT device 112 is to be communicated with (for example, in response to a user or automated request for communication). In step 120, the external device 102 transmits a request to the apparatus 104 to request that the IoT device 112 is to be communicated with. This may be considered to be a connection request from the external apparatus 102 to the apparatus 104 for the external apparatus 102 to connect to the IoT device 112.

In step 122, the request to the IoT device 112 is buffered, managed by the apparatus 104, and retained while communication with the IoT 112 device is made. This may be useful as, generally, the apparatus 102 is not concerned about when the IoT device 112 is online or not (in terms of requesting communication with the IoT device 112), provided it can communicate with the IoT device 112 when the IoT device 112 is next online. The apparatus 104 therefore acts as a management apparatus, managing requests for communication with the IoT device 112 from the external apparatus 102.

In step 124, the apparatus 104 transmits a request to the mobile network 106 that monitoring for device reachability is applied for the identifier of the IoT device 112 (e.g. as obtained in the process shown in FIG. 2). That is, the apparatus 104 sends a request 124 to the mobile network to monitor for the IoT device 112 coming online. In step 126, the mobile network 106 sets up monitoring for the IoT device 112 so that it can determine when the IoT device 112 comes online.

Thus, as in FIG. 2, the apparatus 104 may be configured to transmit a monitoring request 124 to a mobile network 106 to cause the mobile network 106 to monitor 126 for a change of network status of the IoT device 112 from the offline state to the online state. The apparatus 104, as shown, may be configured to receive the connection request 120; and store the connection request in a buffer 122. The connection request 120 may include a unique identifier of the IoT device 112. The unique identifier may include, for example, an IMEI, MSISDN, IMSI, SUPI, SUCI, PEI, or GPSI, or other identifier of the IoT device. In this way the IoT device 112 is identified to the apparatus 104 so the apparatus 104 can facilitate obtaining a notification from the mobile network 106 when the IoT device 112 comes online and can be communicated with.

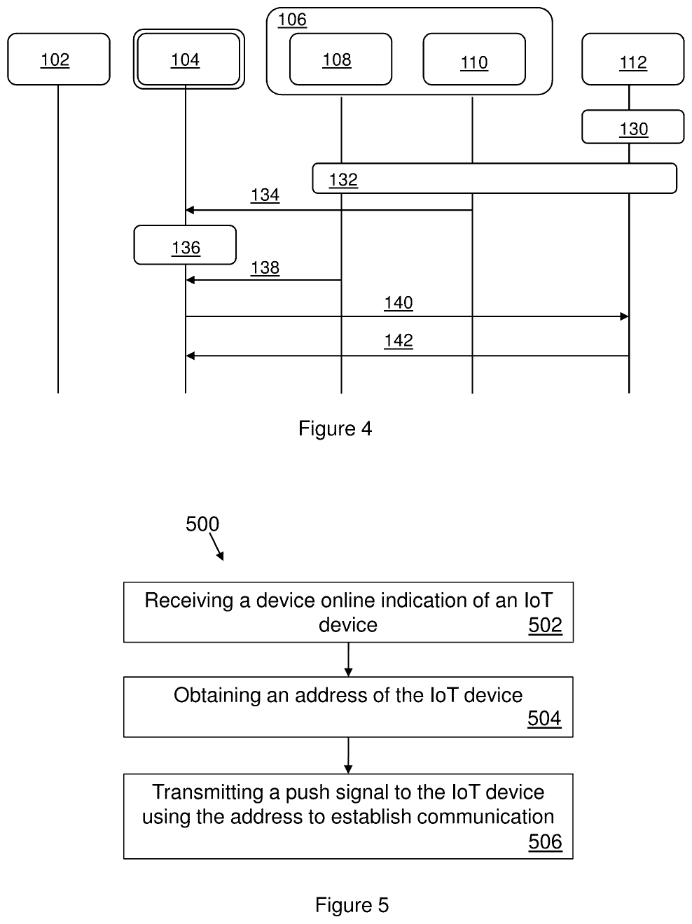

The process of the external device 102 requesting connection with the IoT device 112 may be thought of as the apparatus 104 being configured to: receive a connection request 120 for connection to the IoT device 112 from the external apparatus 102; and being configured to query the network status 124 of the IoT device 112 in dependence on receipt of the connection request 120 from the external apparatus 102. In turn this may cause receipt of the device online indication indicative of the change of network status of the IoT device 112 from the offline state to the online state, as described in relation to FIG. 4.

FIG. 4 shows an example of connecting to an IoT device 112. The process of FIG. 4 follows that of FIG. 2 and FIG. 3, and illustrates how the apparatus 104 may facilitate communication with an IoT device 112 once the IoT device 112 comes online 130.

In step 130, the IoT device 112 comes online. The IoT device 112 can then connect to the mobile network 106, and is allocated an IP address in step 132 e.g. by the mobile network 106. In step 134, the allocated IP address is communicated to the apparatus 104 by the mobile network 106 (as shown, communicated by the IP address notifier 110 of the mobile network 106). This step 134 may be considered to be receipt, by the apparatus 104, of an IoT device network connection notification 134 from the mobile network 106 as the device online indication. The IoT device 112 network connection notification 134 is indicative of detection, by the mobile network 106, that the IoT device 112 has changed network status from the offline state to the online state 130.

In step 136, using the allocated IP address, the IoT device 112 can be identified on the mobile network 106. The apparatus 104 may thus be considered to be configured to obtain the address of the IoT device 112 by receiving an IoT device address allocation 134 from the mobile network 106 (e.g. from the IP address notifier 110 of the mobile network 106). The IoT device address allocation 134 is indicative of the address of the IoT device 112 allocated to the IoT device by the mobile network 106. The IoT address allocation may be determined using accounting information in the mobile network 106. In some examples, such as those using IPV6 networks or other examples in which a static IP address is used (i.e. the IP address does not change) then step 136 may be omitted.

In step 138, because the IoT device 112 has been determined to have come online, this determination is communicated from the exposure feature 108 of the mobile network 106 to the apparatus 104. The apparatus 104 may thus be considered to be configured to receive the IoT device network connection notification 138 via an exposure feature 108 of the mobile network 106.

In step 140, because the IoT device 112 IP address is now known, and it is known that the IoT device 112 is online, the IoT device 112 is contacted (i.e. with no or negligible delay) by the apparatus 104 and is notified that it is to communicate with the apparatus 104. This step may be considered to be a push notification. That is, the apparatus 104, as shown, may be configured to receive the connection request 120, and store the connection request in a buffer 122, as shown in FIG. 3, then transmit the push signal 140 to the IoT device 112, in dependence on the obtaining 134 of the address of the IoT device 112. Advantageously, the push notification 140 is sent after receiving both the information that the IoT device 112 is online, and obtaining the IP address 134 of the IoT device 112. Thus, the apparatus 104 does not (e.g. periodically, repeatedly) send push notifications to request communication contact with the IoT device 112 until the IoT device happens to come online as detected by the mobile network 106, and so the described process is more computationally efficient. Further, when the apparatus 104 does send a push notification to the IoT device 112 to establish communication with the IoT device 112, the apparatus 104 advantageously already has access to the address of the IoT device 112.

Then in step 142, the communication between the IoT device 112 and the apparatus 104 is established.

In some examples, the apparatus 104 may make use of a “Connection ID” process, whereby, for example, a unique identifier (which may be called a connection identifier) of the IoT device 112 is generated, or obtained, during a handshake process between the apparatus 104 and the IoT device 112. Therefore, even if the IP address of the IoT device 112 changes, the communication session can continue using the unique connection identifier. That is, the apparatus 104 may be configured to, following obtaining of the address of the IoT device 134, establish a connection identifier indicative of a communication session between the IoT device 112 and the apparatus 104. Thus, if the address of the IoT device 112 changes, the apparatus 104 may be configured to continue communication with the IoT device 112 using the connection identifier.

This is advantageous in the event of the address of the IoT device 112 changing (and the IoT device address may change, for example, if it is a dynamic address managed by the mobile network 106, as opposed to a static IP address), as the communication session can still continue using the connection identifier established by the apparatus 104. As another example, if an IoT device 112 goes to sleep or extended sleep (i.e. it powers down to avoid expending battery power) and the IP address of the IoT device 112 changes on wake-up (i.e. powering up) the apparatus 104 is still able to communicate with the IoT device 112. The use of the “Connection ID” concept may be made to establish the connection identifier of the IoT device 112 by the apparatus 104, to re-establish a secure connection to an IoT device, regardless of the IP addresses that the IoT device has used previously.

Following establishing the communication 142 between the apparatus 104 and the IoT device 112, the apparatus 104 may be configured to transmit a message received from the external apparatus 102 to the IoT device 112. Following establishing the communication 142 between the apparatus 104 and the IoT device 112, the apparatus 104 may be configured to transmit a message received from the IoT device 112 to the external apparatus 102. Thereby, the apparatus 104 may facilitate communication between the external apparatus 102 and the IoT device 112. In other examples, the apparatus 104 may inform the external apparatus 102 of the communication connection available for the IoT device 112 (i.e. an online status and known address of the IoT device 112) so the external apparatus 102 can communicate with the IoT device 112. In some examples the external apparatus 102 may be part of the apparatus and any such communication by the apparatus 104 to the external apparatus 102 may be internal to the apparatus 102.

In some examples, following establishing the communication between the apparatus 104 and the IoT device 112, the apparatus 104 may be configured to one or more of: transmit a message to the IoT device 112; receive a message from the IoT device 112; transmit a message to the external apparatus 102; and receive a message from the external apparatus 102. Thereby, the apparatus 104 may facilitate communication between the external apparatus 102 and the IoT device 112 and/or between itself 104 and the external apparatus 102 and/or the IoT device 112.

FIG. 5 shows an example method 500 of communication with IoT device. The method 500 is computer-implemented and includes: receiving a device online indication 502 indicative of a change of network status of an IoT device from an offline state to an online state; obtaining an address of the IoT device 504 in dependence on the change of network status of the IoT device from the offline state to the online state; and transmitting a push signal to the IoT device 506 using the address to establish communication between the apparatus and the IoT device.

This disclosure also includes a computer readable medium including computer software which, when executed, is arranged to perform any method disclosed herein such as the method 500 of FIG. 5, and/or according to any of FIGS. 2 to 4. The computer readable medium may be a non-transitory, computer-readable storage medium storing instructions thereon that, when executed by one or more electronic processors, causes the one or more electronic processors to carry out any method disclosed herein. The computer readable medium may be a non-transitory, non-volatile or non-transient storage medium that may include any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM and EEPROM); flash memory; electrical or other types of medium for storing such information/instructions.

The one or more electronic processors may be the processor(s) 1004 of the apparatus 104. The apparatus 104 may include one or more electronic processors 1004 (e.g., a microprocessor, a microcontroller, an application specific integrated circuit (ASIC), Boolean logic circuitry, etc.) that is configured to execute electronic instructions. The term “apparatus”, “server” or “device” may be understood to include a single apparatus, server, or device, and a plurality of apparatuses, servers, and devices collectively operating to provide the required control functionality.

The set of instructions may be embedded in said one or more electronic processors 1004 of the server 102; may be stored in the memory 1002, or may be provided as software to be executed in the apparatus 104. The memory 1002 may include any suitable memory device and may store a variety of data, data structures, and/or instructions thereon. For example, the memory 1002 may store instructions for software, firmware, programs, algorithms, scripts, applications that may control or cause suitable apparatus to perform all or part of the methodology described herein.

Examples disclosed herein facilitate communication between at least one IoT device 112, and an external apparatus 102 or apparatus 104 including an external apparatus 102 (and equally, between an application configured to run on an external apparatus 102 or the apparatus 104). In examples where a 4G mobile network 106 is used, the existing Service Capability Exposure Function, SCEF, may be used to determine when an IoT device 112 comes online for a push notification from the apparatus 104 to the IoT device 112 to establish communication with the IoT device 112. In examples where a 5G mobile network 106 is used, the existing Network Exposure Function, NEF, may be used to determine when an IoT device 112 comes online for a push notification from the apparatus 104 to the IoT device 112 to establish communication with the IoT device 112. Accounting information in the mobile network 106 may be used to automatically determine the IP address of an IoT device 112. Advantageously, communication with an IoT device in an energy efficient and timely way may be made according to examples disclosed herein using existing mobile network protocols.

1. An apparatus comprising a memory configured to store computer-readable instructions; and a processor configured to execute the computer-readable instructions which, when executed, cause the apparatus to:
receive a device online indication indicative of a change of network status of an Internet of Things (IoT) device from an offline state to an online state;
obtain an address of the IoT device in dependence on the change of network status of the IoT device from the offline state to the online state; and
transmit a push signal to the IoT device using the address to establish communication between the apparatus and the IoT device.

2. The apparatus of claim 1, wherein the apparatus is configured to:
transmit a monitoring request to a mobile network to cause the mobile network to monitor for a change of network status of the IoT device from the offline state to the online state; and
receive an IoT device network connection notification from the mobile network as the device online indication, the IoT device network connection notification indicative of detection, by the mobile network, that the IoT device has changed network status from the offline state to the online state.

3. The apparatus of claim 2, wherein the apparatus is configured to receive the IoT device network connection notification via an exposure feature of the mobile network.

4. The apparatus of claim 3, wherein:
if the mobile network is a 4G network, the apparatus is configured to receive the IoT device network connection notification using an Service Capability Exposure Function (SCEF) of the exposure feature; and
if the mobile network is a 5G network, the apparatus is configured to receive the IoT device network connection notification using a Network Exposure Function (NEF) of the exposure feature.

5. The apparatus of claim 2, wherein the apparatus is configured to obtain the address of the IoT device by:
receiving an IoT device address allocation from the mobile network, the IoT device address allocation indicative of the address of the IoT device allocated to the IoT device by the mobile network.

6. The apparatus of claim 5, wherein the IoT address allocation is determined using accounting information in the mobile network.

7. The apparatus of claim 1, wherein the apparatus is configured to: following obtaining of the address of the IoT device, establish a connection identifier indicative of a communication session between the IoT device and the apparatus; and
if the address of the IoT device changes, the apparatus is configured to continue communication with the IoT device using the connection identifier.

8. The apparatus of claim 1, wherein the apparatus is configured to:
receive a connection request for connection to the IoT device from an external apparatus; and
query the network status of the IoT device in dependence on receipt of the connection request from the external apparatus, to cause receipt of the device online indication indicative of the change of network status of the IoT device from the offline state to the online state.

9. The apparatus of claim 8, wherein the connection request comprises a unique identifier of the IoT device;
optionally, wherein the unique identifier comprises an International Mobile Equipment Identity (IMEI) Mobile Station International Subscriber Directory Number (MSISDN) International Mobile Subscriber Identity (IMSI) Subscription Permanent Identifier (SUPI) Subscriber Concealed Identifier (SUCI) Permanent Equipment identifier (PEI) or Generic Public Subscription Identifier (GPSI) of the IoT device.

10. The apparatus of claim 8, wherein, following establishing the communication between the apparatus and the IoT device, the apparatus is configured to one or more of:
transmit a message received from the external apparatus to the IoT device; and
transmit a message received from the IoT device to the external apparatus;
thereby facilitating communication between the external apparatus and the IoT device.

11. A system for communication with an IoT device, the system comprising:
the apparatus of claim 1; and
the IoT device.

12. The system of claim 11, comprising an external apparatus, wherein the apparatus is configured to:
receive a connection request for connection to the IoT device from an external apparatus; and
query the network status of the IoT device in dependence on receipt of the connection request from the external apparatus, to cause receipt of the device online indication indicative of the change of network status of the IoT device from the offline state to the online state.

13. The system of claim 10, wherein the IoT device is one or more of: a gas meter, an electricity meter, a water meter, a sensor, an alarm, a smoke alarm, a carbon monoxide alarm, an intruder alarm, or a climate controller.

14. A computer-implemented method for communication with an IoT device, the method comprising:
receiving a device online indication indicative of a change of network status of an Internet of Things (IoT) device from an offline state to an online state;
obtaining an address of the IoT device in dependence on the change of network status of the IoT device from the offline state to the online state; and
transmitting a push signal to the IoT device using the address to establish communication between the apparatus and the IoT device.

15. A non-transitory computer readable medium comprising computer software which, when executed, is arranged to perform a method according to claim 14.
